(19) United States
(12) Patent Application Publication
(10) Pub. No.: US 2002/0094770 A1
(43) Pub. Date: Jul. 18, 2002

(54) Striking device

(76) Inventor: Ivan Zelka, Augsburg (DE)

Correspondence Address: HARRISON AND EGBERT, 412 MAIN STREET, 7TH FLOOR, HOUSTON, TX, 77002, US

(21) Appl. No.: 09/758,280

(22) Filed: Jan. 12, 2001

(51) Int. Cl. A22B 3/02

(52) U.S. Cl. 452/61

(57) ABSTRACT

A striking device for stunning and/or killing smaller animals for slaughtering, and fish in particular, is proposed which ensures simple and secure handling and high reliability. This new striking device comprises a shaft-like carrying body on which is held a striking shackle at one of the ends which can be tensioned against the action of a spring force and a tensioning device which is associated with the latter and which is provided with a swiveling lever with a handle-like trigger and an engaging tooth which can be brought into and out of combing engagement with an end claw which is provided on the free end of the striking shackle, with the outermost curve of movement of said tooth intersecting the outermost curve of movement of the end claw.

### FIELD OF THE INVENTION

The invention relates to a striking device for stunning and/or killing smaller animals for slaughtering, in particular fishes, with a shaft-like carrying body on which are received a striking shackle, which is held at one end and can be tensioned against the action of a spring force, and a tensioning device which is associated with the same.

### BACKGROUND OF THE INVENTION

A striking device of this kind is known from DE patent specification 138 526. In this known arrangement the tensioning device comprises a swivelable tensioning lever which is provided with a handle and for the tensioning of a striking spring which is associated with the striking shackle is connectable with the same by means of a chain. After the performed tensioning process the chain is removed from the striking spring. The tensioned striking spring can be blocked by an arm of a trigger lever which is independent of the tensioning lever. The performance of the tensioning process by means of a tensioning lever which can be attached by means of a chain to the striking spring requires two-hand operation and is therefore cumbersome. Moreover, it is not possible with the known arrangement to perform several strikes successively in short order without removing the striking device from the animal to be slaughtered. The known arrangement has therefore proven to be difficult to handle, unsafe and user-unfriendly.

DE 91 03 738 U1 shows a stationary apparatus for killing fish with two semimonocoque shells which are mutually adjustable and form a shell for depositing the animal to be slaughtered. It comprises a striking shackle which penetrates a free space between said semimonocopue shells and is arranged as the arm of a two-arm lever whose other arm, on which a tensioning spring acts, cooperates with a tensioning device. It contains a rotatable shaft with a flange which carries two cams whose curve of movement intersects the curve of movement of the associated lever arm. It is also not possible in this case to perform several short strikes successively in with merely one hand. Moreover, the stationary arrangement is unsuitable for mobile use during fishing, etc.

### SUMMARY OF THE INVENTION

Based on this it is therefore the object of the present invention to improve an apparatus of the kind mentioned above with simple and inexpensive means in which high security, user-friendliness and reliability are achieved.

This object is achieved in accordance with the invention in such a way that the tensioning device comprises a swiveling lever with a handle-like trigger and an end claw which is provided at the free end of the striking shackle and can be brought into and out of engagement with an engaging tooth whose outermost curve of movement intersects the outermost curve of movement of the claw.

These measures not only ensure that the striking device in accordance with the invention can be positioned in a purposeful manner and can be triggered by actuating the trigger, with the striking shackle precisely hitting the desired position, but it also advantageously allows the repeated actuation of the trigger so as to perform several strikes occurring successively in short order without having to remove the operating hand from the striking device and the latter from the animal to be slaughtered. The measures in accordance with the invention accordingly lead to a high amount of user-friendliness, security and reliability.

Preferable arrangements and appropriate further developments of the aforementioned measures are stated in the subordinate claims. Accordingly, the striking movement of the striking shackle can appropriately be limited by a stop. A particularly high amount of functional and operational security is thus achieved.

Preferably, the engaging tooth of the tensioning device can be provided with a flank which is arranged as a pressure face and as a stop face. The pressure face can be used to press down and tension the striking shackle until the mutual stop faces of the engaging tooth and the end claw no longer overlap one another as a result of the thus occurring swiveling movements and therefore come out of engagement. The stop face which is opposite of the pressure face facilitates the latching of the end claw of the striking shackle under the upcoming engaging tooth, which shackle rests on the associated stop after performing the strike.

A further advantageous measure can be that the trigger of the swiveling lever can be moved away by a throw-off spring from the shaft-like carrying body and can be placed on the carrying body for tensioning the striking shackle. This ensures that the engaging tooth is automatically brought to the engagement position during an unlocking of the swiveling lever, thus making the apparatus ready for triggering.

In a further development of the aforementioned measures the striking shackle can be arranged as a free leg of a leg spring which is received with its winding on a bearing pin and whose second leg rests on the carrying body. As a result of the arrangement of the striking shackle as a spring it is ensured that an additional spring which is associated with the striking shackle is not required, which ensures a particularly simple and compact design.

The carrying body can appropriately be provided with a concave edge groove which is associated with the striking shackle, into which the striking shackle immerses with a middle section during the performance of a strike. This measure increases the target precision and thus the security. At the same time, this also constitutes a precautionary measure against accidents and improper use of the striking device in accordance with the invention on larger animals.

A further, particularly preferable measure can be that the striking shackle is associated with a striking hammer which is provided with a spike. A particularly high effectiveness and reliability are achieved in this way.

The striking shackle can preferably be arranged in the zone of one end of the shaft-like carrying body which is provided in the zone of its other end with a cutting blade. This enables useful handling and simultaneously provides a combined device which can be used for stunning and performing a stab into the heart, which further increases user convenience.

Further preferable embodiments and appropriate further developments of the aforementioned measures are disclosed in the other subordinate claims and the following description of the example by reference to the enclosed drawings.

### BRIEF DESCRIPTION OF THE PREFERRED EMBODIMENTS

In the drawings described hereunder shaws:

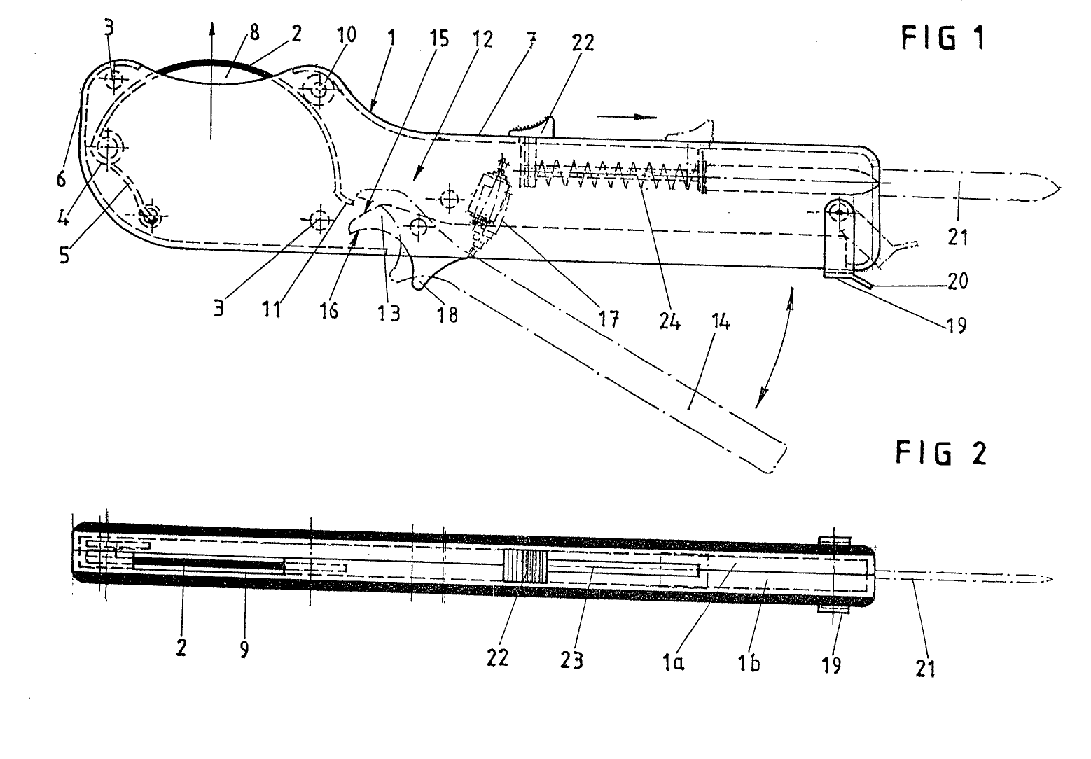

FIG. 1 a side view of a striking device in accordance with the invention,

FIG. 2 a top of FIG. 1 and

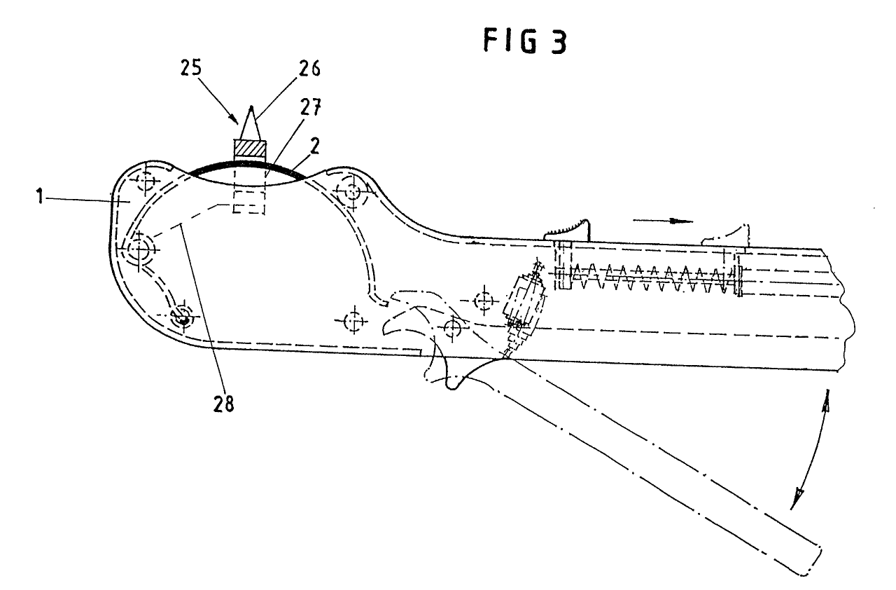

FIG. 3 an example with an added spike in a representation corresponding to FIG. 1.

### DESCRIPTION OF THE PREFERRED EMBODIMENTS

The striking device on which the drawings are based comprises a shaft-like carrying body 1 in which are received a striking shackle 2 which can be driven by spring force and can be tensioned against the propelling force of the same and a tensioning device which is associated with said striking shackle. As is best shown in FIG. 2, the carrying body consists of two trough-like housing parts 1a, 1b which rest partly on one another with their bordering edges and are mutually connected by cross-pins 3. The striking shackle 2 formed by a free semicircularly bent leg of a leg spring which is received with its winding 4 on a bearing pin in form of a cross-pin which connects the two housing parts 1a, 1b and whose second leg 5 rests on the carrying body 1, which in this case is also a cross-pin connecting the housing parts.

The carrying body 1 is widened in the zone of one end associated with striking shackle 2, thus practically leading to a head 6 which is associated with the striking shackle 2 and is located at the end of a handle-like butt 7. The carrying body 1 is provided with a concave recess 8 in the edge in the zone of head 6 and is associated with the striking shackle 2. The striking shackle 2 immerses into said recess during the performance of a strike with a middle arch section of its outwardly convex shape, i.e. in the striking direction. The two housing parts 1a, 1b are recessed in the zone of the recess 8 in the edge that a pass-through slot 9 for the striking shackle 2 is obtained. The outwardly proceeding striking direction is indicated in FIG. 1 with an arrow.

The striking movement of the striking shackle and thus also the immersion depth of the striking shackle 2 in the recess 8 in the edge is limited by a limit stop 10 on which the striking shackle 2 rests after performing the strike with a zone which is situated within the carrying body 1, as is shown in FIG. 1. In order to form the limit stop 10, a cross-pin can be simply provided, which cross-pin connects the two housing parts 1a and 1b. In the illustrated example the limit stop 10 comprises a damping sleeve which is received on such a cross-pin. The limit stop 10 is arranged in such a way that the free end of the striking shackle 2 cannot emerge from the carrying body. Said free end of the striking shackle 2 is bent in the form of an end claw 11 which forms an engagement member which can be brought into engagement with the aforementioned tensioning device for the purpose of tensioning the resilient striking shackle 2.

The tensioning device, which is designated in its entirety with reference numeral 12, comprises a two-arm swiveling lever which is swivelably held on the carrying body 1.

A cross-pin can again be used as a swiveling axis, with said cross-pin connecting the two housing parts 1a, 1b. The short arm of the two-arm swiveling lever which faces the striking shackle 2 is arranged as an engaging tooth 13 which can be brought into and out of combing engagement with the end claw 11. The opposite longer arm of the two-arm swiveling lever acts as a handle-like trigger 14. The swiveling lever is arranged such that the curve of movement of the outermost tip of the engaging tooth which is concentric to the swiveling axis and the curve of movement of the outermost tip of the end claw 11 of the striking shackle 2, which curve of movement is approximately concentric to the bearing of the leg spring comprising the striking shackle 2, are mutually intersected. As a result, the engaging tooth 13 and the end claw 11 cannot pass one another without colliding, but can be brought into combing engagement instead, which is completed after a specific path which is sufficient to tension the striking shackle 2.

Once the strike has been completed, the striking shackle 2 rests on the associated stop 10, as is shown in FIG. 1. When the engaging tooth 13 of the tensioning device 12 is moved past the end claw 11 in the striking direction, i.e. against the tensioning direction, when the striking shackle 2 rests on stop 10 by bringing the swiveling lever of the tensioning device 12 to the position as is indicated in FIG. 1 with the dot-dash line, a collision with the end claw 11 occurs, with the same receding at first resiliently and than latching under the engaging tooth 13. In order to facilitate this process, the outside flank, i.e. the flank of the engaging tooth 13 facing in the striking direction, is arranged as a bent or slanted stop face 15 along which the end claw 11 can slide during the run up of the engaging tooth 13.

The opposite interior flank of the engaging tooth 13 is preferably arranged as a plane pressure face 16 which after the latching of the end claw 11 under the engaging tooth 13 can transmit a supporting force on the end claw 11. The pressure face 16 entrains the end claw 11 of the striking shackle 2 during a movement of the engaging tooth 13 in the tensioning direction (which is downward in the illustrated example), thus tensioning the same in a direction opposite of its own spring force. In the course of this tensioning movement the mutual overlap of end claw 11 and pressure face 16 of the engaging tooth 13 decreases automatically, because the curves of movement of these two members is curved in opposite directions. The tensioning process is ended once the end claw 11 and the engaging tooth 13 no longer have any mutual overlap and are accordingly out of engagement. Practically, this is the case at the point of intersection of the mutual curves of movement of the outermost tips of said two members.

The thus released striking shackle 2 snaps back to the position as shown in FIG. 1 under the action of its spring force, with an impact being exerted on an object situated in the zone of the edge recess 8. In case of necessity, several successive strikes can be performed by actuating the trigger 14 of the tensioning device 12 several times successively.

In order to facilitate handling and operation of the striking device in accordance with the invention, the tensioning device 12 comprises a spring 17 which is associated with the two-arm lever and is arranged in such a way that the trigger 14 is moved away from the carrying body 1 under its effect, with the engaging tooth 13 jumping over the end claw 11 of the striking shackle 2 resting on the stop 10, as is indicated with the dot-dash lines. As soon as the trigger 14 is moved towards the carrying body 1, the striking shackle 2 is tensioned at first and then released, thus performing a strike.

In the illustrated example the trigger 14 can be immersed in the carrying body 1, leading to a particularly convenient handling and compact arrangement. The housing parts 1a, 1b which form the carrying body 1 are recessed accordingly in the zone of the trigger 14 in such a way that a retraction slot is produced which is associated with the trigger 14. In order to activate the trigger 14 it is enclosed by the fingers of the hand in which carrying body 1 is held with its butt 7. In order to prevent any slipping of the trigger 14, the swiveling lever can be provided with a projection 18 which acts as a stop and is located in the zone of the transition between engaging tooth 13 and trigger 14.

The swiveling lever comprising the trigger 14 can be locked when the trigger 14 is placed against the carrying body 1 or retracted in the carrying body 1, as is the case here. For this purpose there is provided in the present example a swivelably arranged eyelet-like locking bar 19 at the rear end of the carrying body 1 which can be brought into and out of engagement with the trigger 14. In order to facilitate the actuation, the locking bar 19 can be provided with an actuating bracket 20. When the locking bar 19 is activated, trigger 14 is held in engagement on locking bar 19 by spring 17, thus stabilizing the locking.

A piercing blade 21 is provided in the zone of the end of butt 7 of carrying body 1 which is averted from the head 6 which is assigned to the striking shackle 2. It is connected with a slider 22 and can be extended rearwardly out of butt 7 of carrying body 1 with the help of slider 22. Slider 22 is displaceably arranged on butt 7 for this purpose and is provided with a projection penetrating slot 23 on which blade 21 is fixed. The housing parts 1a, 1b are recessed on the side in order to form slot 23. The piercing blade 21 is associated with a pull-back spring 24 by means of which the piercing blade 21 is automatically retracted into carrying body 1 once the slider 22 is released. During the extension of the piercing blade 21 by means of slider 22 the pull-back spring 24 is tensioned.

The striking device in accordance with the invention allows performing the stunning and killing of smaller animals to be slaughtered, and fishes in particular, according to regulations. When a fisher has caught a fish, the fisher positions the striking device on the head of the fish in such a way that the head of the fish immerses into the edge recess 8 which is assigned to the striking shackle 2 and is hit accordingly by the striking shackle 2 once the trigger 14 is actuated. In case of necessity, as was already mentioned above, several successive strikes can be performed by repeated actuation of the trigger 14. The fish is thus reliably stunned and in some cases even killed. In order to ensure secure killing, it is necessary to perform thereafter a piercing of the heart, etc. For this purpose the piercing blade 21 is actuated against the action of the pull-back spring 24.

FIG. 3 shows a striking device with a striking shackle provided with an add-on device. The arrangement of the striking device can correspond in all other features to the arrangement according to FIGS. 1 and 2. The same reference numerals are therefore used for the same parts.

In the example of FIG. 3, a striking hammer 25 is assigned to the striking shackle 2, which hammer can be actuated by means of the striking shackle 2. The striking hammer 25 is provided with a spike 26 which projects in the striking direction which practically acts as a chisel. It is introduced by means of the striking shackle 2 into the cranial bone of the respective animal, thus ensuring a quick and reliable killing. This additional measure is applied in particular on relatively large and strong animals such as heavy fish of prey.

In the illustrated example the striking hammer 25 is arranged as a rider-like add-on of the striking shackle 2. The add-on can be attached on the striking shackle. Appropriately, however, the striking shackle 2 is movable towards the striking hammer 25 in the tensioning direction. This allows performing several successive strikes for advancing the striking hammer 25 without having to retract its spike 26. In the illustrated example the striking hammer 25 is provided with an oblong hole or slot 27 penetrated by the striking shackle 2 with a respective play. In order to achieve a favorable striking effect, the striking hammer is applied to the tensioned striking shackle. For this purpose a spring 28 is provided which rests on the housing 1 and is arranged in this case as a leg spring. It is substantially weaker than the spring used by the striking shackle 2 and is thus overcome by the striking shackle.

In order to secure a precise alignment of the striking hammer it can be movably guided in the striking direction on carrying body I and be provided with a stop which cooperates with the carrying body 1 and prevents that the striking hammer 25 comes out of engagement with the guidance or can be lost. Insofar as the striking hammer is provided with an oblong recess 27 which is penetrated by striking shackle 2, its end acts as a stop.

What is claimed is

1. A striking device for stunning and/or killing smaller animals for slaughtering, and fishes in particular, with a shaft-like carrying body on which is held a striking shackle at one of the ends which can be tensioned against the action of a spring force and a tensioning device which is associated with the latter and which is provided with a swiveling lever with a handle-like trigger and an engaging tooth which can be brought into and out of combing engagement with an end claw which is provided on the free end of the striking shackle, with the outermost curve of movement of said tooth intersecting the outermost curve of movement of the end claw.

2. A striking device as claimed in claim 1, whereby the striking movement of the striking shackle is limited by a stop.

3. A striking device as claimed in claim 1, whereby the end claw of the striking shackle resting on the stop can be resiliently latched beneath the engaging tooth.

4. A striking device as claimed in claim 1, whereby the engaging tooth is provided with flanks which are arranged as a stop face and as a pressure face.

5. A striking device as claimed in claim 1, whereby the trigger of the tensioning device can be moved away from the carrying body by a spacing spring and can be moved towards the carrying body to tension the striking shackle .

6. A striking device as claimed in claim 1, whereby the trigger can be locked in the end position on the carrying body side.

7. A striking device as claimed in claim 1, whereby the trigger can be sunk in the carrying body.

8. A striking device as claimed in claim 1, whereby the striking shackle is arranged as a spring.

9. A striking device as claimed in claim 1, whereby the striking shackle is arranged as a free leg of a leg spring which is received with its winding on a bearing pin and whose second leg rests on the carrying body.

10. A striking device as claimed in claim 1, whereby the striking shackle is provided with a configuration which is convex in the striking direction.

11. A striking device as claimed in claim 1, whereby the carrying body is provided with a concave recess in the edge which is associated with the striking shackle and in which the striking shackle immerses with its middle section of the bend when performing a strike.

12. A striking device as claimed in claim 1, whereby the carrying body comprises a head which is associated with the striking shackle and from which a butt projects.

13. A striking device as claimed in claim 1, whereby the carrying body is provided with a piercing blade in the zone of its end which is further remote from the striking shackle .

14. A striking device as claimed in claim 13, whereby the piercing blade can be extended by means of a slider against the action of a pull-back spring from the butt of the carrying body.

15. A striking device as claimed in claim 1, whereby the carrying body is provided with two housing parts (1a, 1b) which are mutually connected by cross-pins and rest at least partly on one another with their edges.

16. A striking device as claimed in claim 1, whereby a striking hammer is associated with the striking shackle.

17. A striking device as claimed in claim 16, whereby the striking hammer is provided with a spike.

18. A striking device as claimed in claim 16, whereby the striking hammer is movable in the tensioning direction with respect to the striking shackle and can be placed on the tensioned striking shackle by means of a spring.
